(19) United States
(12) Patent Application Publication
(10) Pub. No.: US 2012/0199276 A1
(43) Pub. Date: Aug. 9, 2012

(54) Tubular Liner for Underground Pipes and Method of Installing Tubular Liner

(75) Inventor: Gerhardt John Rodenberger, Califon, NJ (US)

(73) Assignee: Spiniello Companies, Livingston, NJ (US)

(21) Appl. No.: 13/021,891

(22) Filed: Feb. 7, 2011

(51) Int. Cl. B32B 37/00; B32B 3/00; B32B 5/26

(52) U.S. Cl. 156/215; 442/326; 428/190

(57) ABSTRACT

A method of rehabilitating a pipeline with a liner and a novel liner for that purpose are disclosed. The method comprises reinforcing the liner with a layer of fiber-reinforced mat such as carbon fiber reinforced mat only at one or more locations along the length of the liner corresponding to the location and length of one or more bends in the pipeline. The liner includes the fiber-reinforced mat only at locations or sections along its length which correspond to bends in the pipeline being rehabilitated so that when the liner is inverted when installing it in the pipeline, the areas of reinforcement align with the bends.

### BACKGROUND OF THE INVENTION

The present invention relates to the field of tubular liners for underground pipes, more particularly to “cured in place pipe” (CIPP) and methods of installing such CIPP in existing conduits, especially pressure cured in place pipe (PCIPP) suitable for carrying potable water.

CIPP technology was pioneered by Eric Wood who founded Insituform (Pipes and Structures) Limited in the early 1970's and first patented by Woods. See U.S. Pat. No. 4,009,063 which disclosed a method of lining a passageway with a hard, rigid pipe of thermosetting resin, wherein a tubular fibrous felt is immersed in the resin to form a carrier for the resin. The immersed felt and resin have an inflatable tube therein and this tube is inflated to shape the resin to the passageway surface. The resin is cured to form the hard, rigid lining pipe with the felt embedded therein. According to the CIPP method, a felt tube saturated with a polyester resin is inserted into an existing conduit such as a sewer via water inversion or air inversion. Once the liner is installed, the liner is heated to a point that the resin cures and hardens to become a new pipe within the existing pipe.

Over the past decade developments have been made with the resin and liners to include fiberglass in the felt to create a product that could withstand pressure. Initially these pressure liners (PCIPP) were installed in sewer mains. Also during this time resins were developed that were nontoxic, non-VOC and ultimately National Science Foundation (NSF)-approved for potable (drinking) water.

Currently Insituform and Norditube manufacture PCIPP NSF-approved liner materials which utilize fiberglass for tensile properties by methods disclosed in U.S. Pat. Nos. 6,923,217; 6,932,116; and U.S. Pat. Pub. 2006/0228501, which are hereby incorporated by reference. Fiberglass strands give the product the ability to withstand internal pressure. One of the difficulties with fiberglass-reinforced PCIPP is its inability to negotiate certain bends in existing conduit and then withstand the internal pressure in the bend. An inherent problem with any fiber-reinforced material is that when it negotiates a bend the outer radius flattens out very slightly. This flattening prevents the fiberglass from behaving in a purely hoop stress and more like a bending stress. Ultimately the fiberglass will rupture in this bend location at a pressure sometimes as much as 66% lower than the pressure a straight section can withstand.

It is an object of the present invention to improve the ability of PCIPP conduit liner material to withstand internal pressure in a conduit which includes a bend.

### SUMMARY OF THE INVENTION

These objects, and others which will become apparent from the following disclosure and accompanying drawings, are achieved by the present invention which comprises a method of rehabilitating a pipeline with a liner and a novel liner for that purpose. The method comprises reinforcing the liner with a layer of fiber-reinforced mat such as carbon fiber-reinforced mat only at one or more locations along the length of the liner corresponding to the location and length of one or more bends in the pipeline. The liner includes the fiber-reinforced mat only at locations or sections along its length which correspond to bends in the pipeline being rehabilitated so that when the liner is inverted when installing it in the pipeline, the areas of reinforcement align with the bends. The fiber-reinforced mat can be slightly longer than the length of the bend, usually about 105 to 115% of the length of the bend, and in some cases somewhat longer or shorter than the usual amount.

In another aspect the invention comprises a tubular liner for reinforcing conduits comprising a composite of concentric layers of felt, fiberglass, and polyethylene-coated material along the entire length of the liner, the pipeline to be reinforced having one or more bends, and the liner comprising a concentric layer of carbon fiber-reinforced material between a layer of felt and the polyethylene-coated material only at each location along the length of the liner which corresponds to the location of the one or more bends along the length of pipeline to be reinforced. The tubular liner can be manufactured and provided in a flat, folded or rolled form with the polyethylene coated material layer on the outside and a felt layer on the inside, with one or more fiberglass layers in between, and is introduced into a pipeline by a method known in the art as eversion, wherein the liner becomes the tubular or other shape of the pipeline, the polyethylene coated felt layer becomes the inside layer and the felt layer becomes the outside layer which contacts the pipeline. The polyethylene layer is an impervious material. In certain embodiments at least one fiberglass sheet includes free overlap portions on both edges which overlap at least two locations, wherein said overlap portions on both edges extend in a lengthwise direction of the inner tubular jacket and wherein the overlap portions are situated at diametrically opposed locations covering flattening folds of the tubular lining material. According to the invention the liner further comprises at least one sheet of reinforced mat, for example carbon fiber, located only in each section corresponding to a bend in the conduit and arranged such that when the tubular lining material is advanced within the conduit and turned inside out, each section located within a bend comprises the at least one sheet of reinforced mat. The reinforced mat can be longer than the length of the bend to which it corresponds, preferably about 105-115% of the length of the bend.

In another aspect, the invention comprises a method of rehabilitating a pipeline with a liner comprising (A) determining plan and profile of the pipeline from drawings and field verification; (B) calculating the length of liner needed to line the pipeline; (C) determining the location and length of each bend in the pipeline; (D) manufacturing a liner having a length calculated in step (B) as a composite of a plurality of layers along the entire length of the liner; (E) reinforcing the liner with a layer of fiber-reinforced mat only at one or more locations along the length of the liner corresponding to the location and length of one or more bends in the pipeline determined in step (C); (F) inserting and inverting the tubular liner in the pipeline so that the one or more locations of the liner reinforced with the layer of fiber-reinforced mat is or are located at the corresponding bend.

The tubular fiberglass-reinforced PCIPP lining material is strengthened only in the areas where the material will line a bend in a conduit by placing carbon fiber in those areas. Although carbon fiber is well known to be a stronger material than fiberglass, it is significantly more expensive and more difficult to work with and so it is never used in practice. According to the invention the carbon fiber is more able to resist bending stress in the bends of the conduit.

In some embodiments two sheets of fiberglass are included and in some embodiments two sheets of reinforcing mat are included. Either or both of the fiberglass and the reinforcing mat can be provided as two sheets, each being approximately ½ of the circumference of the tube as after it is inverted. Each fiber reinforced mat can have a length in some embodiments of about 105% to 110% of the length of the corresponding bend where it will be placed in the tube.

### BRIEF DESCRIPTION OF THE DRAWINGS

The description set forth above, as well as other objects, features and advantages of the present invention, will be more fully appreciated by referring to the detailed description and the drawings that follow. The description is of the presently preferred but, nonetheless, illustrative embodiments in accordance with the present invention, when taken in conjunction with the accompanying drawing wherein:

FIG. 1 is a cross-sectional side view of a non-inverted liner of the invention.

FIG. 2 is a plan view of the tubular liner of FIG. 1, inverted and installed in a conduit having straight sections and two bends.

FIG. 3 is a cross-sectional view through III-III of FIG. 2.

FIG. 4 is a cross-sectional view through IV-IV of FIG. 2, showing carbon fiber reinforcement in the area corresponding to the bend in the conduit.

FIG. 5 is a schematic view of a liner being everted in a pipeline.

### DETAILED DESCRIPTION

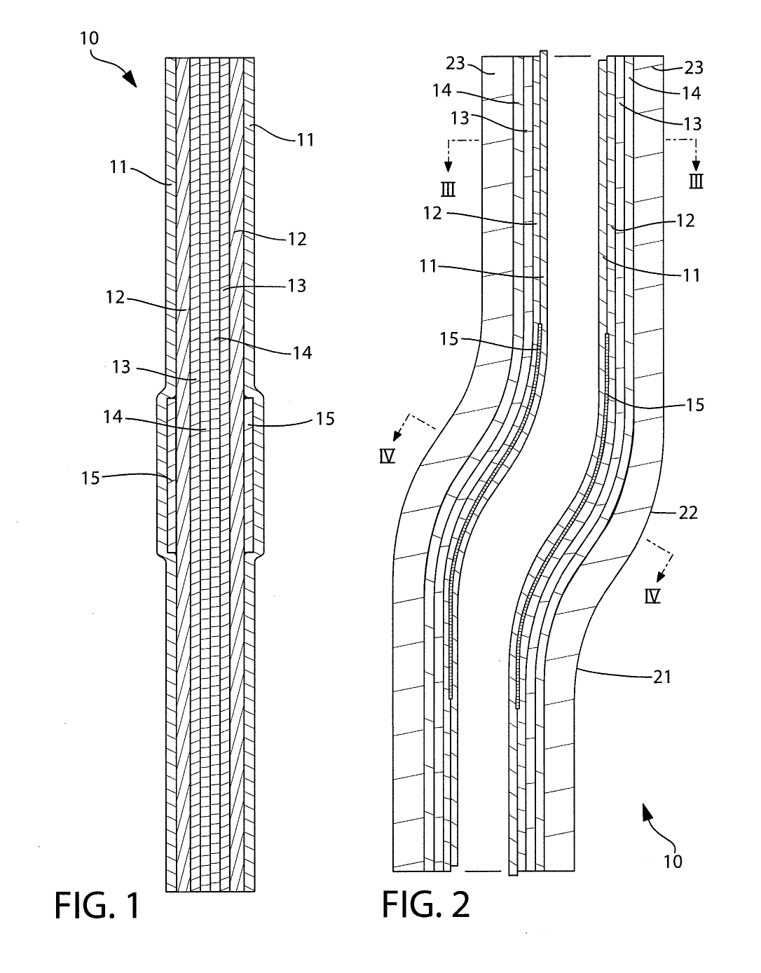

Reference is now made generally to FIG. 1 wherein a cross-sectional side view of a non-inverted liner 10 of the invention is shown. The non-inverted liner 10 is comprised of polyethyelene coated felt layer 11 which will become the innermost layer upon inversion, two layers of fiberglass, 12, 13, and an second felt layer 14 which will become the outermost layer which faces the pipeline upon inversion of liner 10. According to the invention, a carbon fiber layer 15 between the polyethylene coated felt layer 11 and the first fiberglass layer 12 is included in the non-inverted liner only at one or more selected places along the length of the liner, in the illustrated embodiment specifically at areas along the length of the liner 10 which will correspond to bends 21, 22 (FIG. 2) in the pipeline 23 (FIG. 2) where the liner 10 is to be installed by inversion. The carbon fiber layer 15 is about 105-115% of the length of the bend so it will slightly overlap the length of the bend. When the liner 10 is installed in a pipeline 23 by inversion, the carbon fiber layer 15 will be located at the bends 21, 22 and in some embodiments will extend slightly longer than the length of the bends 21, 22. Rather than including the carbon fiber layer 15 between the polyethylene coated felt layer 11 and the first fiberglass layer 12, carbon fiber layer 15 can be located between felt layer 14 and fiberglass layer 13. It is also optional to have either two fiberglass layers 12 and 13 or only one fiberglass layer.

Referring now to FIG. 2, a cross-sectional plan view of a liner 10 which has been inverted and installed in pipeline 23 is shown. Carbon fiber layer 15 is located at 45° bend 20 and −45° bend 22. The carbon fiber layer 15 is included at strategic locations only and not along the entire length of the tube 10 in order to strengthen the tube at locations which will be subject to the greatest stress while keeping the overall weight and cost of the tube lower than would be the case if the carbon fiber layers were included along the entire length of the tube 10.

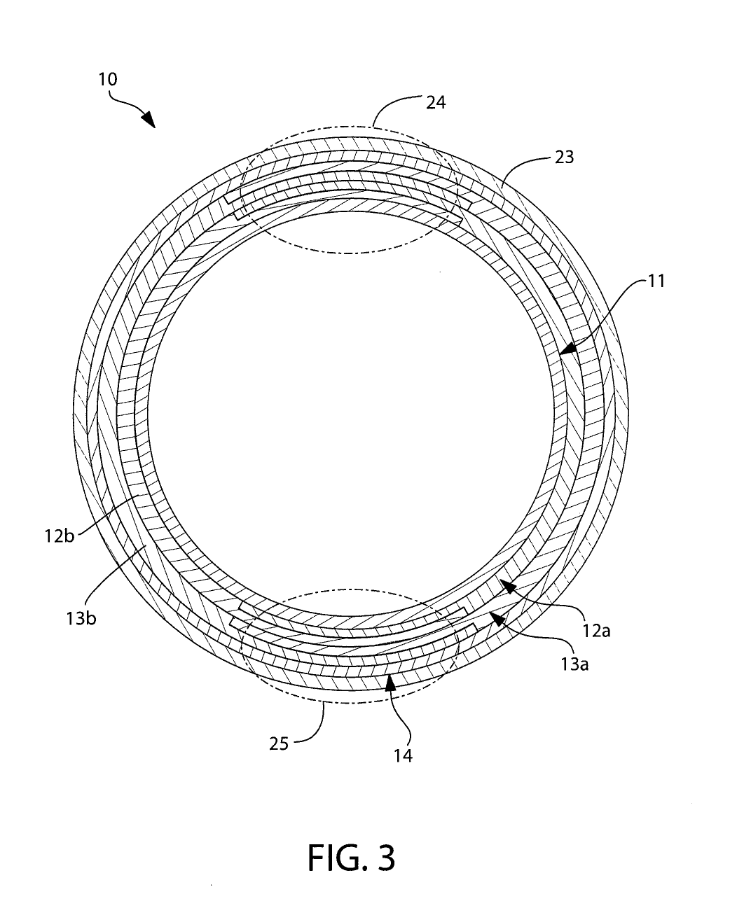

A cross-section through III-III of FIG. 2 is illustrated in FIG. 3 wherein the inverted liner 10 is installed in pipeline 23 so that outer felt layer 14 is adjacent to the pipeline 23, and two fiberglass layers are each comprised of two sections, each of which are slightly longer than half the inner circumference of the pipeline 23 so that each pair of sections overlaps at the top 24 and bottom 25, the areas of overlap 24, 25 shown in dash lined circles. The areas of overlap 24, 25 are not necessarily at the top and bottom of the pipeline but can be at the left and right or any other opposing locations. In FIG. 3, the first layer of fiberglass is composed of right half 12a and left half 12b, and the second layer of fiberglass is composed on right half 13a and left half 13b. In some embodiments, the second layer of fiberglass can be eliminated. An innermost polyethylene coated felt layer 11 is adjacent to the first fiberglass layer 12a, 12b. Polyethylene coated felt layer 11 is the layer of the liner which comes into contact with water or other fluid flowing within the pipeline 23. This cross-section through III-III of FIG. 2 is consistent throughout most of the length of the tube 10.

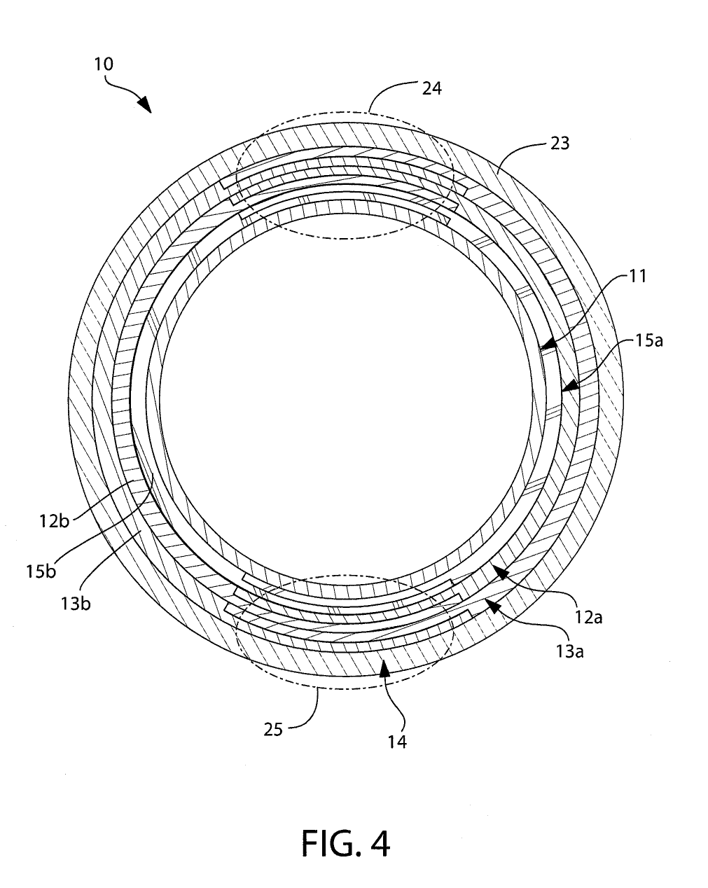

A cross-section through IV-IV of FIG. 2 is shown in FIG. 4 which differs from the cross-section through III-III illustrated in FIG. 3 in that a carbon fiber layer, comprised of a pair of sections 15a, 15b, is located between innermost polyethylene coated felt layer 11 and inner felt layer 16. This cross-section through IV-IV of FIG. 2 is only consistent for the selected areas corresponding to the bends in pipeline 23. Carbon fiber is the preferred reinforcing material to use in such selected areas but other high strength to weight and to volume materials can be used if they are equally effective as the carbon fiber.

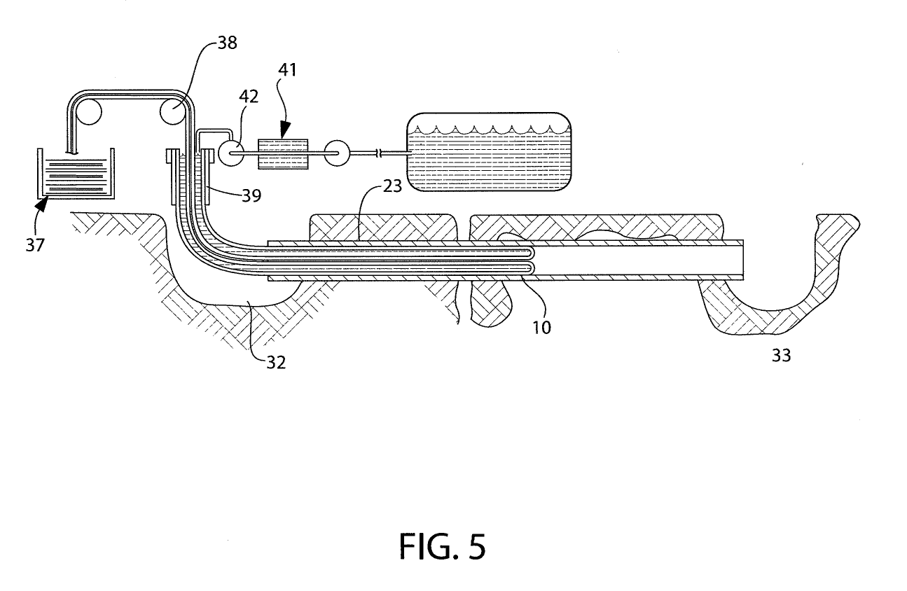

Referring now to FIG. 5, a schematic illustration of a typical eversion of a cured in place pipe liner 10 for rehabilitation of an existing conduit 23 from a first access pit 32 to a second access pit 33. An impregnated composite liner 10 is supplied in a folded configuration 37. Liner 10 is fed over rollers 38 to a down tube 39 in a form of an elbow terminating at access to an underground conduit 23. Liner 10 is fed through down tube 39, folded back and banded to the endpoint of down tube 39. An everting fluid, such as air pressure can be used to install the liner 10 in the pipe 23. In other embodiments water in a reservoir 41 is fed via a pump 42 to down tube 39 thereby turning liner 10 inside out and into existing conduit 23. Rather than employing such as reservoir 41 and pump 42, it is usually preferable to use an existing fire hydrant for the source of the water under pressure. Resin impregnated into liner 10 can be cured by any known means, for example by steam. After curing, liner 10 becomes a new pipe within existing conduit 23.

It has been found that in a tubular liner for installation in existing underground pipes such as water pipes which include bends, a special layer of fiber reinforcement in the portions of the tubular liner which will be located in the areas of the bends is an innovation which improves the useful life of the tubular liner and greatly reduces the risk of failure of the liner due to higher pressures from the fluid in the pipe at the bends. Carbon fiber reinforcement, which is relatively expensive as compared with the conventional fiberglass liner layers normally used in tubular liners in this art, is used only in selected locations according to the invention, rather than along the entire length of the tubular liner as the other layers are used.

The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. The invention is capable of considerable modification, alteration and equivalents in form and function, as will occur to those ordinarily skilled in the pertinent arts. The depicted and described preferred embodiments of the invention are exemplary only and are not exhaustive of the scope of the invention. Consequently, the invention is intended to be limited only by the spirit and scope of the appended claims, giving full cognizance to equivalents in all respects.

What is claimed is:

1. A method of rehabilitating a pipeline with a liner comprising (A) determining plan and profile of the pipeline from drawings and field verification; (B) calculating the length of liner needed to line the pipeline; (C) determining the location and length of each bend in the pipeline; (D) manufacturing a liner having a length calculated in step (B) as a composite of a plurality of layers along the entire length of the liner; (E) reinforcing the liner with a layer of fiber-reinforced mat only at one or more locations along the length of the liner corresponding to the location and length of one or more bends in the pipeline determined in step (C); (F) inserting and inverting the tubular liner in the pipeline so that the one or more locations of the liner reinforced with the layer of fiber-reinforced mat is or are located at the corresponding bend.

2. The method of claim 1 wherein the reinforced mat is carbon fiber reinforced mat.

3. The method of claim 1 wherein the liner is a composite comprising concentric layers of felt, fiberglass, and polyethylene-coated material along the entire length of the liner, the pipeline to be reinforced having one or more bends, and the liner comprising a concentric layer of carbon fiber-reinforced material between a layer of felt and the polyethylene-coated material only at each location along the length of the liner which corresponds to the location of the one or more bends along the length of pipeline to be reinforced.

4. The method of claim 1 wherein the two sheets of fiber reinforced mat has a length which is about 105% to 110% of the length of the corresponding bend.

5. The method of claim 1 wherein the fiber reinforced mat is carbon fiber reinforced mat; wherein the liner comprises concentric layers of felt, fiberglass, and polyethylene-coated material along the entire length of the liner, the pipeline to be reinforced having one or more bends, and the liner comprising a concentric layer of carbon fiber-reinforced material between a layer of felt and the polyethylene-coated material only at each location along the length of the liner which corresponds to the location of the one or more bends along the length of pipeline to be reinforced; and wherein the two sheets of fiber reinforced mat has a length which is about 105% to 110% of the length of the corresponding bend.

6. A liner for reinforcing a pipeline, the liner having a length at least as long as the pipeline to be reinforced, comprising a composite of concentric layers of felt, fiberglass, and polyethylene-coated material along the entire length of the liner, the pipeline to be reinforced having one or more bends, and the liner comprising a concentric layer of carbon fiber-reinforced material between a layer of felt and the polyethylene-coated material only at each location along the length of the liner which corresponds to the location of the one or more bends along the length of pipeline to be reinforced.

7. The tubular lining material of claim 6 wherein the concentric layer of carbon fiber-reinforced material is carbon fiber reinforced mat.

8. The liner of claim 6 wherein one or more layer of fiberglass comprises at least two sheets of fiberglass, each sheet having a width of less than the circumference of the tube and located at opposing sides of the liner along the length of the liner and including free overlap portions which overlap at least two locations, wherein said overlap portions extend in a lengthwise direction of the liner and wherein the overlap portions are situated at diametrically opposed locations covering flattening folds of the tubular lining.

9. The tubular lining material of claim 6 wherein the length of each layer of carbon fiber-reinforced material at each respective location along the length of the liner has a length of about 105% to 115% of the length of the respective one or more bends.

10. The tubular lining material of claim 6 wherein the at least two sheets of fiber reinforced mat located only on each section of the tubular lining material which corresponds to a bend in the pipeline include free overlap portions on both edges which overlap at least two locations.

11. The tubular lining material of claim 6 wherein fiber reinforced mat located only on each location of the liner which corresponds to a bend in the pipeline is carbon fiber reinforced mat; have a length of about 105% to 115% of the length of the bend; and include free overlap portions on both edges which overlap at least two locations.
